(19) United States
(12) Patent Application Publication
(10) Pub. No.: US 2023/0199568 A1
(43) Pub. Date: Jun. 22, 2023

(54) QUALITY OF SERVICE MANAGEMENT IN A TELECOMMUNICATIONS NETWORK

(71) Applicant: Telefonaktiebolaget LM Ericsson (publ), Stockholm (SE)

(72) Inventors: Alexander Vesely, FELDBACH (AT); Paul Schliwa-Bertling, LJUNGSBRO (SE); Yazid Lyazidi, HÄSSELBY (SE); Juying Gan, SHANGHAI (CN)

(21) Appl. No.: 17/926,650

(22) PCT Filed: May 25, 2021
(86) PCT No.: PCT/EP2021/063899

§ 371 Date: Nov. 21, 2022

Related U.S. Application Data
(60) Provisional application No. 63/032,423, filed on May 29, 2020.

(51) Int. Cl. H04W 28/24

(52) U.S. Cl. CPC H04W 28/24

(57) ABSTRACT

There is provided a method for managing a quality of service (QoS) in a telecommunications network. The method is performed by a first network node of the telecommunications network. If the first network node is unable to fulfil a first QoS indicated in a least preferred alternative QoS profile of one or more alternative QoS profiles, a first message is signalled to a core network node. The first message comprises a first indication that indicates that the first network node is unable to fulfil the first QoS indicated in the least preferred alternative QoS profile.

### TECHNICAL FIELD

The present disclosure relates generally to communications, and more particularly to communication methods and related nodes for managing quality of service (QoS) in a telecommunications network.

### BACKGROUND

An alternative QoS profile(s) can be optionally provided for a guaranteed bit rate (GBR) QoS flow with notification control enabled. If a corresponding policy and charging control (PCC) rule contains related information (as described in 3GPP TS 23.503), a session management function (SMF) network node may provide, in addition to an initial QoS profile, a prioritized list of alternative QoS profile(s) to a network node (e.g., a next generation radio access network (NG-RAN) node).

An alternative QoS profile can represent a combination of QoS parameters to which application traffic may be able to adapt.

When the network node (e.g., NG-RAN node) sends a notification to the SMF network node that the initial QoS profile is not fulfilled, the NG-RAN node can, if the currently fulfilled parameters (e.g. values) match an alternative QoS profile, include also the reference to the alternative QoS profile to indicate the QoS that the NG-RAN node currently fulfils.

### SUMMARY

According to an aspect of the disclosure, there is provided a first method for managing a quality of service (QoS) in a telecommunications network. The first method is performed by a first network node of the telecommunications network. The first method comprises, if the first network node is unable to fulfil a first QoS indicated in a least preferred alternative QoS profile of one or more alternative QoS profiles, signalling a first message to a core network node. The first message comprises a first indication that indicates that the first network node is unable to fulfil the first QoS indicated in the least preferred alternative QoS profile.

According to another aspect of the disclosure, there is provided a second method for managing a QoS in a telecommunications network. The second method is performed by a core network node in the telecommunications network. The second method comprises, if a first network node is unable to fulfil a first QoS indicated in a least preferred alternative QoS profile of one or more alternative QoS profiles, receiving a first message from the first network node. The first message comprises a first indication that indicates that the first network node is unable to fulfil the first QoS indicated in the least preferred alternative QoS profile.

According to another aspect of the disclosure, there is provided a first network node comprising processing circuitry configured to operate in accordance with the first method. In some embodiments, the first network node may comprise at least one memory for storing instructions which, when executed by the processing circuitry, cause the first network node to operate in accordance with the first method.

According to another aspect of the disclosure, there is provided a core network node comprising processing circuitry configured to operate in accordance with the second method. In some embodiments, the core network node may comprise at least one memory for storing instructions which, when executed by the processing circuitry, cause the core network node to operate in accordance with the second method.

According to another aspect of the disclosure, there is provided a telecommunications network comprising the first network node described earlier and the core network node described earlier.

According to another aspect of the disclosure, there is provided a computer program comprising instructions which, when executed by processing circuitry, cause the processing circuitry to perform the first method and/or the second method.

According to another aspect of the disclosure, there is provided a computer program product, embodied on a non-transitory machine-readable medium, comprising instructions which are executable by processing circuitry to cause the processing circuitry to perform the first method and/or the second method.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a block diagram illustrating an example of a telecommunication network representing fifth generation (5G) wireless system network architecture including a first network node and core network functions (NFs);

FIG. 2 is a block diagram illustrating an example of a first network node including a split central unit and a radio unit according to some embodiments;

FIG. 3 is a block diagram illustrating a method performed by a first network node according to an embodiment;

FIG. 4 is a block diagram illustrating a method performed by a core network node according to an embodiment;

FIG. 5 is a signal flow diagram illustrating an example of operations in a telecommunication network according to some embodiments;

FIG. 6 is a block diagram illustrating an example of a first network node according to some embodiments;

FIG. 7 is a block diagram illustrating an example of a core network node according to some embodiments;

FIGS. 8-10 are flow charts illustrating examples of operations of a first network node according to some embodiments of the present disclosure;

FIGS. 11-12 are flow charts illustrating examples of operations of a core network node according to some embodiments of the present disclosure;

FIG. 13 is a block diagram of a wireless network in accordance with some embodiments;

FIG. 14 is a block diagram of a user equipment in accordance with some embodiments;

FIG. 15 is a block diagram of a virtualization environment in accordance with some embodiments;

FIG. 16 is a block diagram of a telecommunication network connected via an intermediate network to a host computer in accordance with some embodiments;

FIG. 17 is a block diagram of a host computer communicating via a base station with a user equipment over a partially wireless connection in accordance with some embodiments; and

FIGS. 18-21 are block diagrams of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Support of an alternative QoS profile, e.g. in notification control, will now be discussed.

While some embodiments discussed herein are explained in the non-limiting context of a first network node that can be a radio access network (RAN) node, such as a next generation radio access network (NG-RAN) node, the invention is not so limited and can be applied without any loss of meaning to other network nodes, e.g. other radio access network (RAN) nodes. Further, the terms “first network node”, “NG-RAN node”, and “NG-RAN” herein may be used interchangeably.

Further, while some embodiments discussed herein are explained in the non-limiting context of a core network node that can be a session management function (SMF) node, the invention is not so limited and can be applied without any loss of meaning to other core network nodes. Further, the terms “core network node”, “SMF network node”, “SMF node”, and “SMF” herein may be used interchangeably

In some approaches, if a first network node (e.g., a NG-RAN node) receives a list of alternative QoS profile(s) for a QoS flow and supports the alternative QoS profile handling, the following may apply:
1) Before sending a notification that a QoS (e.g. a guaranteed flow bit rate, (GFBR), a packet delay budget (PDB) and/or a packet error rate (PER)) can no longer be guaranteed towards an SMF network node, the NG-RAN may check whether the parameters indicative of the QoS (e.g. the values of the GFBR, PDB and/or PER parameters) that the NG-RAN currently fulfils match any of the alternative QoS profile(s), e.g. in an indicated priority order. If there is a match, the NG-RAN may indicate a reference to the matching alternative QoS profile, e.g. with the highest priority, together with the notification to the SMF.
   If there is no match, the NG-RAN may send a notification that the QoS (e.g. GFBR, PDB and/or PER) can no longer be guaranteed towards the SMF without referencing any of the alternative QoS profile(s) (e.g. unless specific conditions at the NG-RAN require the release of the NG-RAN resources for this (e.g. GBR) QoS flow, e.g. due to a radio link failure or RAN internal congestion).
2) If a notification that the QoS (e.g. GFBR, PDB and/or PER) can no longer be guaranteed has been sent to the SMF and the NG-RAN determines that the currently fulfilled parameters indicative of the QoS (e.g. the values of the GFBR, the PDB and/or the PER) are different from the situation indicated in the last notification, the NG-RAN may send a further notification to the SMF and indicate the currently fulfilled situation.
   It is noted that the fulfilled situation can be either the QoS profile, an alternative QoS profile, or an indication that a lowest priority alternative QoS profile(s) cannot be fulfilled.
3) The NG-RAN may always try to fulfil the parameters (e.g. the values) of the QoS profile and any Alternative QoS Profile, e.g. that has higher priority than the currently fulfilled situation.
   It is noted that, in order to avoid a too frequent signalling to the SMF, it may be assumed that NG-RAN implementation can apply hysteresis (e.g. via a configurable time interval) before notifying the SMF that the currently fulfilled parameters (e.g. values) match the QoS profile or a different alternative QoS profile, e.g. of a higher priority. It may also be assumed that a policy charging function (PCF) ensures that the QoS parameters (e.g. values) within the different alternative QoS profile(s) are not too close to each other.
4) Upon receiving a notification from the NG-RAN that the QoS (e.g. GFBR, PDB and/or PER) can, or can no longer, be guaranteed, the SMF may inform the PCF. If it does so, the SMF may indicate the currently fulfilled situation to the PCF (e.g. as described in 3GPP TS 23.503).
5) If the PCF has not indicated differently, the SMF may use Non-Access Stratum (NAS) signalling (e.g. that is sent transparently through the RAN) to inform a User Equipment (UE) about changes in the QoS parameters (e.g., the 5G QoS Identifier (5QI), GFBR, and/or Maximum Flow Bit Rate (MFBR)) that the NG-RAN is currently fulfilling for the QoS flow, e.g. after notification control or handover related signalling has occurred.

Herein, a QoS flow can be any flow (e.g. data or traffic flow) in a telecommunications network that requires a QoS. For example, a GBR QoS flow can be any flow (e.g. data or traffic flow) in a telecommunications network that requires a guaranteed flow bit rate. A QoS flow can, for example, be between a user equipment (UE) and a core network node via a first network node. Thus, the first network node may need to fulfil a required QoS for a certain QoS flow.

As used herein, a network node (e.g., a first network node) may refer to equipment capable, configured, arranged and/or operable to communicate directly or indirectly with a user equipment and/or with other network nodes or equipment in the telecommunication network (e.g., a radio communication network) to enable and/or provide wireless access to the user equipment and/or to perform other functions (e.g., administration) in the radio communication network. Examples of network nodes include, but are not limited to, base stations (BSs) (e.g., radio base stations, Node Bs, evolved Node Bs (eNBs), NG-RAN node, gNode Bs (gNBs), etc.). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., mobile switching centres (MSCs) and/or mobility management entities (MMEs)), operations and maintenance (O&M) nodes, operating support system (OSS) nodes, self-organizing network (SON) nodes, positioning nodes (e.g., enhanced serving mobile location centres (E-SMLCs)), and/or multicast distribution tree (MDT) nodes. As another example, a node may be a virtual network node.

As used herein, a core network node (e.g., an SMF node) may refer to equipment capable, configured, arranged and/or operable to communicate directly or indirectly with a network node (e.g., a first network node) and/or with other core network nodes or equipment in the telecommunication network (e.g., a radio communication network) to enable and/or provide wireless access to the user equipment and/or to perform other functions (e.g., administration) in the radio communication network. Examples of core network nodes include, but are not limited to, an SMF node, an Access and Mobility Management function (AMF) node, a Policy Control Function (PCF) node, and an Application function (AF) node.

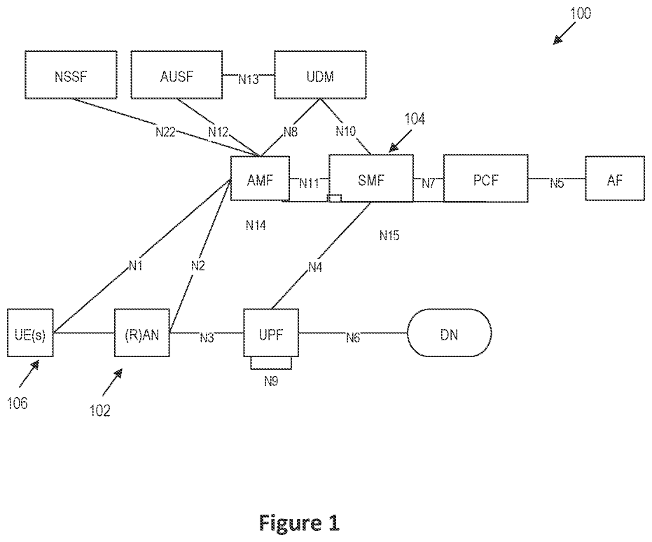

FIG. 1 depicts an example of a telecommunication network 100 represented as a 5G network architecture composed of core network functions (NFs) nodes, where interaction between any two NF nodes is represented by a point-to-point reference point/interface.

On the access side, the 5G network architecture shown in FIG. 1 includes a plurality of User Equipment (UEs) 106 connected to either a Radio Access Network (RAN) or an Access Network (AN) by a wireless interface as well as an Access and Mobility Management Function (AMF). Typically, the R(AN) 102 comprises base stations, such as evolved Node Bs (eNBs) or 5G base stations (gNBs) or similar. On the core network side, the 5G core NF nodes shown in FIG. 1 include a Network Slice Selection Function (NSSF) node, an Authentication Server Function (AUSF) node, a Unified Data Management (UDM) node, an Access and Mobility Management Function (AMF) node, a Session Management Function (SMF) node 104, a Policy Control Function (PCF) node, and an Application Function (AF) node.

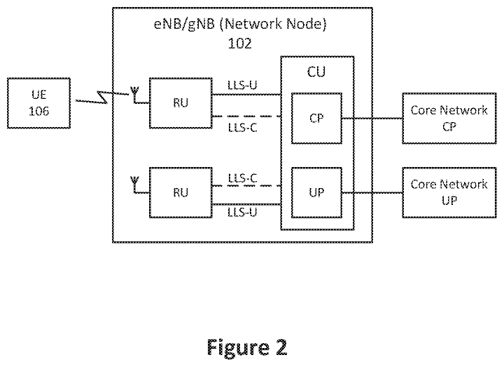

FIG. 2 depicts an example of a first network node 102 according to some embodiments. As illustrated in FIG. 2, the first network node 102 may, for example, be an eNB or a gNB. The first network node 102 can have a split architecture. That is, the first network node 102 can comprise a central (or centralized) unit (CU) and one or more radio units (RU) connected to the CU. An RU may also be referred to as a distributed unit (DU). The CU is capable of interacting with the RU(s) over the control plane(s) (CP(s)) and/or the user plane(s) (UP(s)) on the so-called “fronthaul.” As illustrated, the CU can be a logical node that may include the eNB/gNB functions as discussed below. In this regard, the CU can control the operation of the RU(s) in some embodiments discussed herein. The CU can communicate with the control plane (CP) and user plane (UP) functions of a core network on the backhaul. The RUs may transmit and/or receive downlink and/or uplink data, respectively, to/from one or more user equipment (UE) nodes 106, e.g. via a wireless interface.

In some approaches, e.g. as discussed above, it may not be specified how an NG-RAN indicates that even the lowest priority Alternative QoS Profiles cannot be fulfilled to the SMF.

Various embodiments of the present disclosure may provide solutions to these and other potential problems.

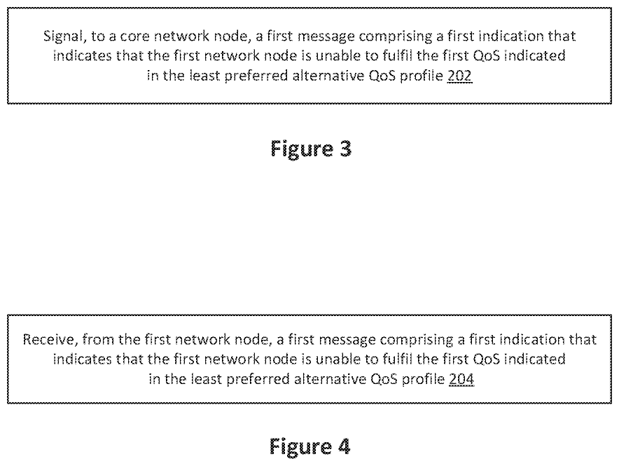

FIG. 3 is a block diagram illustrating a method performed by a first network node according to an embodiment. The method can be performed by or under the control of processing circuitry of the first network node. The method is for managing a QoS in a telecommunications network. The method is performed if the first network node is unable to fulfil a first QoS indicated in a least preferred alternative QoS profile of one or more alternative QoS profiles. As illustrated by block 202 of FIG. 3, a first message is signalled to a core network node. The first message comprises a first indication that indicates that the first network node is unable to fulfil the first QoS indicated in the least preferred alternative QoS profile. Although not illustrated in FIG. 3, in some embodiments, the method may comprise receiving the one or more alternative QoS profiles from the core network node.

Although also not illustrated in FIG. 3, in some embodiments, the may method comprise checking if the first network node fulfils at least one QoS profile of the one or more alternative QoS profiles. In some embodiments, checking if the first network node fulfils at least one QoS profile of the one or more alternative QoS profiles can comprise checking if the first network node fulfils at least the least preferred QoS profile. In some embodiments, checking if the first network node fulfils at least one QoS profile of the one or more alternative QoS profiles can comprise checking the one or more alternative QoS profiles in an order according to a priority corresponding to each of the one or more alternative QoS profiles. In these embodiments, the least preferred alternative QoS profile can be the alternative QoS profile with the lowest priority.

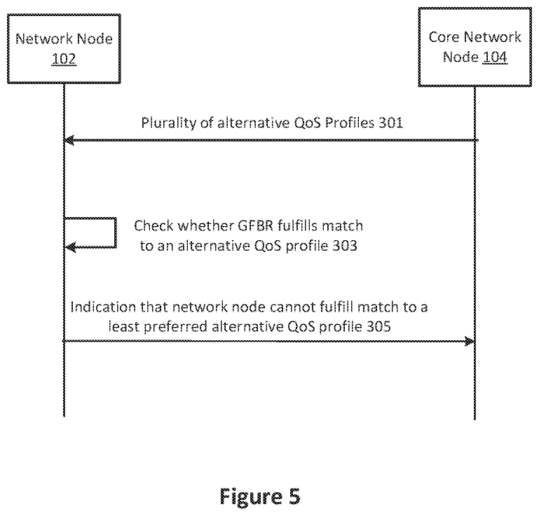

FIG. 4 is a block diagram illustrating a method performed by a core network node according to an embodiment. The method can be performed by or under the control of processing circuitry of the core network node. The method is for managing a QoS in a telecommunications network. The method is performed if the first network node is unable to fulfil a first QoS indicated in a least preferred alternative QoS profile of one or more alternative QoS profiles. As illustrated by block 204 of FIG. 4, a first message is received from the first network node. The first message comprises a first indication that indicates that the first network node is unable to fulfil the first QoS indicated in the least preferred alternative QoS profile. Although not illustrated in FIG. 4, in some embodiments, the method may comprise signalling the one or more alternative QoS profiles to the core network node.

In some embodiments, the first indication referred to herein can be an Information Element (IE) of the first message. In some embodiments, the least preferred alternative QoS profile referred to herein can be an alternative QoS profile with a lowest priority out of the one or more alternative QoS profiles. In some embodiments, the first indication can signal to the core network node that the first network node supports attempting to fulfil the least preferred alternative QoS profile and/or any other alternative QoS profile of the one or more alternative QoS profiles. Alternatively or in addition, in some embodiments, the first indication can signal to the core network node that the first network node is unable to fulfil any of the one or more alternative QoS profiles. In some embodiments, the first network node may be unable to fulfil the first QoS if a second QoS that the first network node is able to fulfil does not match the first QoS.

In some embodiments, the first QoS may be indicated in the least preferred alternative QoS profile by one or more first QoS parameters. In some embodiments, the one or more first QoS parameters can comprise any one or more of a guaranteed flow bit rate (GFBR), a packet delay budget (PDB), a packet error rate (PER), a QoS Identifier (QI, e.g. 5QI), a Maximum Flow Bit Rate (MFBR), and any other QoS parameter.

In some embodiments, the second QoS mentioned earlier may be indicated by one or more second QoS parameters (such as any of the examples provided in respect of the first QoS parameters). In these embodiments, it can be that the second QoS does not match the first QoS if any one of the one or more second QoS parameters do not match a respective one of the one or more first QoS parameters.

In some embodiments, the first indication referred to herein can be a first predefined index, such as an integer value. For example, the integer value may be an integer value of zero. In some embodiments, the first predefined index can be one of a set (e.g. list) of predefined indices comprising at least one second predefined index. In these embodiments, each second predefined index may correspond to one of the one or more alternative QoS profiles. Although not illustrated in FIG. 3, the method performed by the first network node can comprise receiving the set of predefined indices from the core network node. Similarly, although not illustrated in FIG. 4, the method performed by the core network node can comprise signalling the set of predefined indices to the first network node. In some embodiments, each second predefined index can be a different integer value. For example, each second predefined index can be a different integer value from one to N, where N may correspond to the number of alternative QoS profiles.

In various embodiments, the first predefined index (e.g., alternate QoS parameter (AQP) #0) may be included among a list of AQPs as an indication that a currently supported QoS level cannot match even the lowest AQP when the required QoS profile cannot be fulfilled. The first network node (e.g. NG-RAN node) can use this index when notification control is enabled. In some embodiments, the methods described herein (e.g. the methods described with reference to FIGS. 3 and/or 4) can be performed when notification control has been enabled. For example, notification control can indicate whether notifications are requested (e.g. by the core network node) from the first network node to indicate whether or not a QoS can be fulfilled. Specifically, if notification control has been enabled, notifications are requested (e.g. by the core network node) from the first network node to indicate whether or not a QoS can be fulfilled. Thus, if notification control has been enabled, the first network node can be configured to signal to the core network node whether or not a QoS can be fulfilled.

Potential advantages provided by various embodiments of the present disclosure may be that, by including the special value/index (also referred to herein as an indication and/or a defined value) to indicate that the current QoS level cannot match even the lowest AQP when the required QoS profile cannot be fulfilled, it may be possible to avoid protocol impact. It can also be helpful for the core network node (e.g. SMF node) to know when the first network node (e.g. NG-RAN node) is operating at a QoS level below the AQP with lowest requirements as this can, for example, reveal a (e.g. potentially severe) resource limitation of the telecommunications network (e.g. due to bottleneck congestion, scarce allocated resources, etc.) and/or a need for a served area to be prioritised by an operator to provide bitrate resources meeting the minimum QoS level (e.g. by use of solutions such as resource overprovisioning, re-originations of network dimensioning, etc).

In some embodiments, e.g. in a protocol data unit (PDU) session resource notify message, the first network node (e.g. NG-RAN node) may inform the core network node of the QoS flows which are released or not fulfilled anymore or fulfilled again by the first network node (e.g. NG-RAN node).

In some embodiments, for each PDU session for which some QoS flows are not fulfilled anymore, the first network node (e.g. NG-RAN node) may add an indication in the (e.g. GBR) QoS flow information that that the lowest priority alternative QoS profile cannot be supported.

In some embodiments, the method described herein (e.g. the method of FIGS. 3 and/or 4) can be performed in response to a request and/or the first message referred to herein can be a response to that request. The request can be, for example, a request for a protocol data unit (PDU) session resource, a request for a handover of a user equipment from the first network node to a second network node, or a request to switch a path (i.e. a path switch request) for signalling from a user equipment to the core network node. Generally, a path switch request can allow a second network node, after a successful handover, to connect to the core network node and establish a new interface connection for data transmission. In some embodiments where the first message is a response to the request for the handover, the indication may signal to the core network node that the handover is not possible.

In some embodiments, during the event of mobility, in case a target second network node (e.g. NG-RAN node) accepts a handover fulfilling one of the alternative QoS parameters, it can indicate the alternative QoS parameters set which it can currently fulfil, such as in a Current QoS Parameters Set Index information element (IE) within a PDU Session Resources Admitted List IE of a handover request acknowledge message.

In some embodiments, the target second network node can indicate in the (e.g. GBR) QoS flow Information that the lowest priority alternative QoS profile cannot be supported. The source node can interpret it is as an indication that no handover is possible towards that target second network node.

With reference to signalling a first message comprising a first indication (such as an index/defined value) of various embodiments of the present disclosure, the first indication (shown below with underlining) can be included in the following exemplary alternative QoS parameter set index IE indicating the QoS parameters set that can currently be fulfilled:

| | | | | |
|---|---|---|---|---|
| IE/Group | | | IE type and | Semantics |
| Name | Presence | Range | reference | description |

| | | | |
|---|---|---|---|
| Alternative | M | INTEGER | Indicates the |
| QoS | | (0..8,..) | index of the |
| Parameters | | | item within the |
| Set Index | | | Alternative QoS |
| | | | Parameter Set |
| | | | List IE |
| | | | corresponding to |
| | | | the currently |
| | | | fulfilled |
| | | | alternative QoS |
| | | | parameters set. |
| | | | Value 0 |
| | | | indicates that |
| | | | the current |
| | | | supported QoS |
| | | | in gNB cannot |
| | | | match even the |
| | | | least preferred |
| | | | AQP. |

In some embodiments, a first interface can be located between a centralised unit (CU) of the first network node (“gNB-CU”) and a distributed unit (DU) of the first network node (“gNB-DU”). Thus, the CU of the first network node and the DU of the first network node can communicate via the first interface. The first interface may be referred to in the art as the F1 interface. In embodiments where the first network node comprises a CU and a DU, the first network node can be said to have a split architecture. In some embodiments, a second interface can be present at the CU of the first network node. Specifically, the second interface can be located between a user plane (UP) of the CU of the first network node (“gNB-CU-UP”) and a control plane (CP) of the CU of the first network node (“gNB-CU-CP”). The second interface may be referred to in the art as the E1 interface.

In some embodiments, the first message referred to herein can be signalled by the first network node to the core network node in response to the CP of the CU of the first network node receiving a third message from the DU of the first network node. Similarly, in some embodiments, the first message referred to herein can be received by the core network node from the first network node in response to the CP of the CU of the first network node receiving the third message from the DU of the first network node. In these embodiments, the third message can comprise the first indication referred to herein. The third message can also be referred to as an F1 message or an F1 NOTIFY message.

Alternatively or in addition, in some embodiments, the first message referred to herein can be signalled to the core network node in response to the UP of the CU of the first network node receiving a fourth message from the CP of the CU of the first network node. Similarly, in some embodiments, the first message referred to herein can be received by the core network node from the first network node in response to the UP of the CU of the first network node receiving the fourth message from the CP of the CU of the first network node. In these embodiments, the fourth message can comprise the first indication referred to herein. The fourth message can also be referred to as an E1 message or an E1 NOTIFY message.

Although not illustrated in FIG. 3, in some embodiments, the method performed by the first network node can comprise, if the first network node is unable to fulfil the first QoS indicated in the least preferred alternative QoS profile, signalling the third message from the DU of the first network node to the CP of the CU of the first network node and/or signalling the fourth message from the CP of the CU of the first network node to the UP of the CU of the first network node.

In some embodiments, the first indication (e.g. index) referred to herein may be communicated as part of the supported alternative QoS parameters during a path switch request, an F1 NOTIFY message and/or during a signalling of QoS flow Information over the E1 interface (e.g. to a gNB-CU-UP) in case of the split (e.g. gNB) architecture.

Although not illustrated in FIG. 3, in some embodiments, if the first network node is able to fulfil a third QoS indicated in an alternative QoS profile of the one or more alternative QoS profiles, the method performed by the first network node may comprise signalling a second message to the core network node. Similarly, although not illustrated in FIG. 4, in some embodiments, the method performed by the core network node may comprise, if the first network node is able to fulfil a third QoS indicated in an alternative QoS profile of the one or more alternative QoS profiles, receiving the second message from the first network node. The second message can comprise a second indication that indicates the alternative QoS profile that the first network node is able to fulfil.

For example, the first network node may be able to fulfil the third QoS subsequent and/or prior to the first network node being unable to fulfil the first QoS. In some embodiments, it may be that there was no QoS fulfilled prior to the signalling of the first message comprising the first indication. In some embodiments, the alternative QoS profile that the first network node is able to fulfil may be the alternative QoS profile with a highest priority out of the one or more alternative QoS profiles that the first network node is able to fulfil. In some embodiments, the third QoS may be the first QoS and the alternative QoS profile that the first network node is able to fulfil may be the least preferred alternative QoS profile. In some embodiments, the second indication may be a second predefined index (e.g. any of those mentioned earlier) corresponding to the alternative QoS profile that the first network node is able to fulfil.

In some embodiments, the one or more alternative QoS profiles can be alternatives to a requested QoS profile. For example, a certain QoS profile may be requested to be applied to a particular QoS flow. A certain QoS may be requested by the core network node according to some embodiments. For example, a certain QoS may be requested in a request from the core network node to the first network node. The request can be a request to setup a QoS flow, e.g. during a PDU session setup request or a PDU modify request, or any other request. In some of these embodiments, the method described herein (e.g. the method of FIGS. 3 and/or 4) can be performed in response to the first network node being unable to fulfil the requested QoS profile.

In some embodiments, the method described herein (e.g. the method of FIGS. 3 and/or 4) can be performed in response to a QoS flow establishment and/or modification. In some of these embodiments, the QoS flow establishment and/or modification may be rejected if the first network node is unable to fulfil the first QoS.

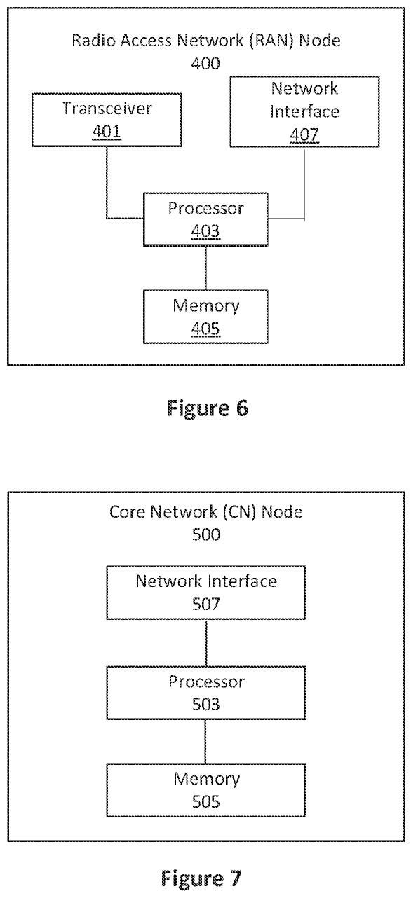

FIG. 5 is a signal flow diagram illustrating an example of operations in a telecommunication network according to some embodiments. As illustrated by arrow 301, the core network node 104 may signal one or more (e.g. a plurality of) alternative QoS profiles to the first network node 102. As illustrated by arrow 303, the first network node 102 may check if the first network node 102 fulfils at least one QoS profile of the one or more alternative QoS profiles, e.g. in the manner described earlier. As illustrated by arrow 305, if the first network node 102 is unable to fulfil a first QoS indicated in a least preferred alternative QoS profile of one or more alternative QoS profiles, the first network node 102 signals the first message to the core network node 104. As described earlier, the first message comprises the first indication that indicates that the first network node 102 is unable to fulfil the first QoS indicated in the least preferred alternative QoS profile.

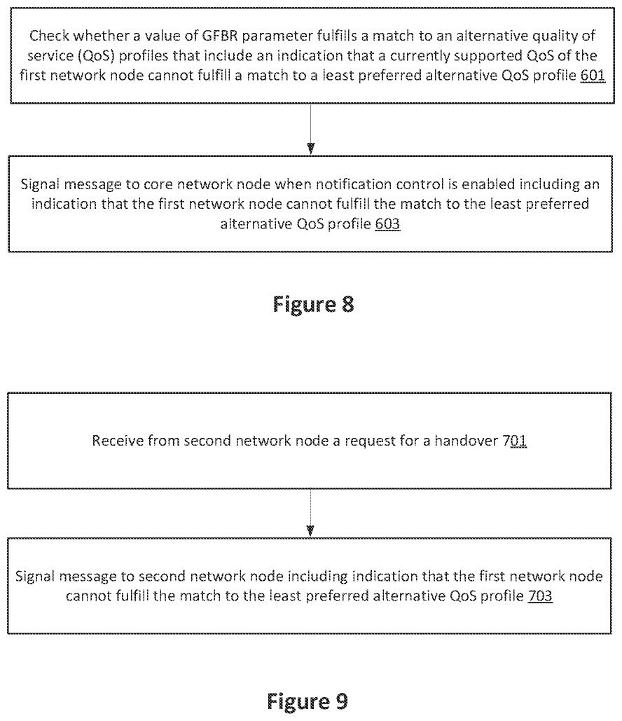

FIG. 6 is a block diagram illustrating elements of a first network node 400 (e.g., network node 102) in a telecommunication network. The first network node 400 may include a transceiver 401. The transceiver 401 can transmit and/or receive any of the messages (and/or any other signalling) described herein. The first network node 400 may include network interface circuitry 407 (also referred to as a network interface) configured to communicate with other nodes or devices. The first network node 400 may include processing circuitry 403 (also referred to as a processor). The first network node 400 may include memory circuitry 405 (also referred to as memory). The memory circuitry 405 may be coupled to the processing circuitry 403. The memory circuitry 405 may include computer readable program code that, when executed by the processing circuitry 403, causes the processing circuitry to perform operations according to embodiments disclosed herein. According to other embodiments, processing circuitry 403 may be defined to include memory so that a separate memory circuitry is not required.

As discussed herein, operations of the first network node 400 may be performed by processing circuitry 403 and network interface 407. For example, processing circuitry 403 may control network interface 407 to receive and/or transmit signals to a core network node. Moreover, modules may be stored in memory 405, and these modules may provide instructions so that when instructions of a module are executed by processing circuitry 403, processing circuitry 403 performs respective operations (e.g., operations discussed above or below with respect to a first network node).

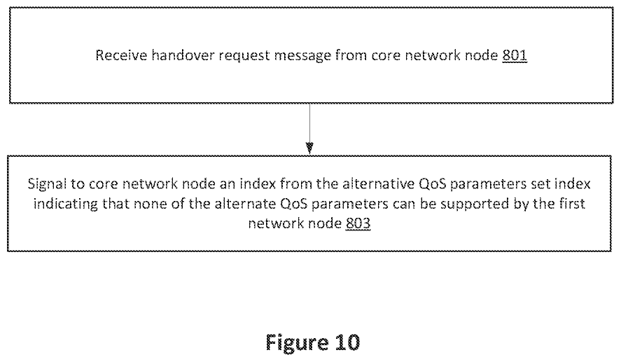

FIG. 7 is a block diagram illustrating elements of a core network node 500 (e.g., core network node 104). The core network node 700 may include network interface circuitry 507 (also referred to as a network interface) configured to communicate with other nodes or devices. The core network node 500 may also include processing circuitry 503 (also referred to as a processor). The core network node 500 may include memory circuitry 505 (also referred to as memory). The memory circuitry 505 may be coupled to the processing circuitry 503. The memory circuitry 505 may include computer readable program code that, when executed by the processing circuitry 503, causes the processing circuitry to perform operations according to embodiments disclosed herein. According to other embodiments, processing circuitry 503 may be defined to include memory so that a separate memory circuitry is not required.

As discussed herein, operations of the core network node 500 may be performed by processing circuitry 503 and network interface 507. For example, processing circuitry 503 may control network interface 507 to receive and/or transmit signals to a network node. Moreover, modules may be stored in memory 505, and these modules may provide instructions so that when instructions of a module are executed by processing circuitry 503, processing circuitry 503 performs respective operations (e.g., operations discussed above or below with respect to a core network node).

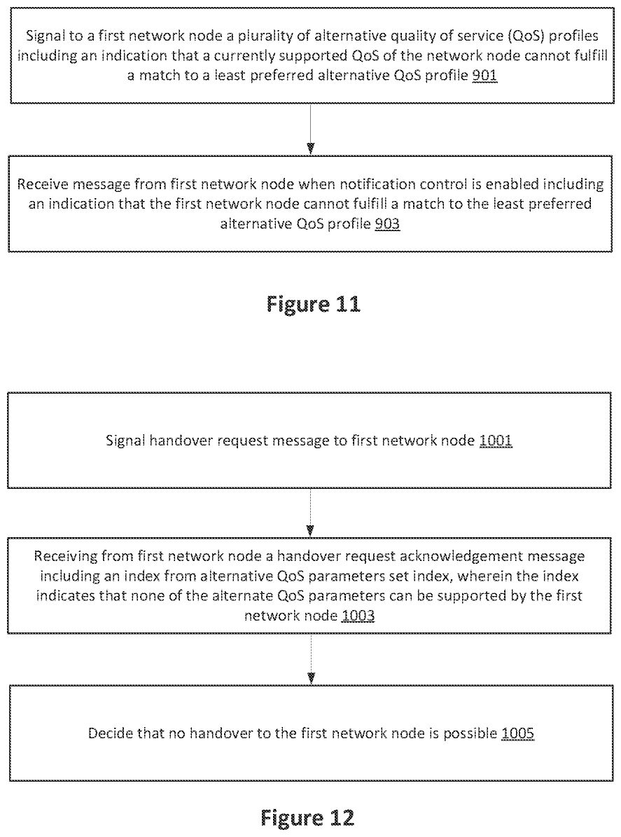

Operations of a first network node 102 (implemented using the structure of FIG. 6) will now be discussed with reference to the flow charts of FIGS. 8-10 according to some embodiments of the present disclosure. For example, modules may be stored in memory 405 of FIG. 6, and these modules may provide instructions so that when the instructions of a module are executed by respective first network node processing circuitry 403, processing circuitry 403 performs respective operations of the flow charts.

Referring initially to FIG. 8, at block 601, processing circuitry 403 checks whether a value of a guaranteed flow bit rate, GFBR, parameter fulfils a match to one of a plurality of alternative quality of service (QoS) profiles. The plurality of alternative QoS profiles includes an indication that a currently supported QoS of the first network node cannot fulfil a match to a least preferred alternative QoS profile. Responsive to the check, at block 603, processing circuitry 403 signals a message to a core network node when notification control is enabled. The message includes an indication that the first network node cannot fulfil the match to the least preferred alternative QoS profile.

In some embodiments, the signalling a message includes signalling a packet date unit, PDU, session resource notify message.

Referring now to FIG. 9, in some embodiments, at block 701 processing circuitry 403 receives from a second network node a request for a handover. Responsive to receiving the request, at block 703, processing circuitry 403 signals a message to the second network node. The message includes the indication that the first network node cannot fulfil the match to the least preferred alternative QoS profile.

In some embodiments, the indication includes a defined value indicating that the currently supported QoS of the first network node cannot fulfil a match to a least preferred alternative QoS profile.

In some embodiments, the indication includes an indication in an alternative QoS parameters set index corresponding to the plurality of alternative QoS profiles.

In some embodiments, the alternative QoS parameters set index is received as a portion of at least one of: a supported alternative QoS parameters received during a path switch request from the core network node; an F1 notify message received from the core network node; and a signalling of QoS flow information over E1 to a central unit of the first network node, wherein the first network node comprises a gNodeB having a split architecture.

Referring now to FIG. 10, in some embodiments, at block 801 processing circuitry 403 receives a handover request message from the core network node. Responsive to the handover request message, at block 803 processing circuitry 403 signals to the core network node an index from the alternative QoS parameters set index. The index indicates that none of the alternate QoS parameters can be supported by the first network node.

In some embodiments, the index indicates to the core network node that no handover to the first network node is possible.

In some embodiments, the alternative QoS parameters set index includes a plurality of parameters having values 1 through N, wherein N is an integer having a value greater than 1, and a parameter having a value of 0 indicating that none of the parameters having values 1 through N can be supported.

Various operations from the flow charts of FIGS. 8-10 may be optional with respect to some embodiments of first network node and related methods. Regarding methods of example embodiment 1 (set forth below), for example, operations of blocks 701, 703, 801 and 803 of FIGS. 9 and 10, respectively, may be optional.

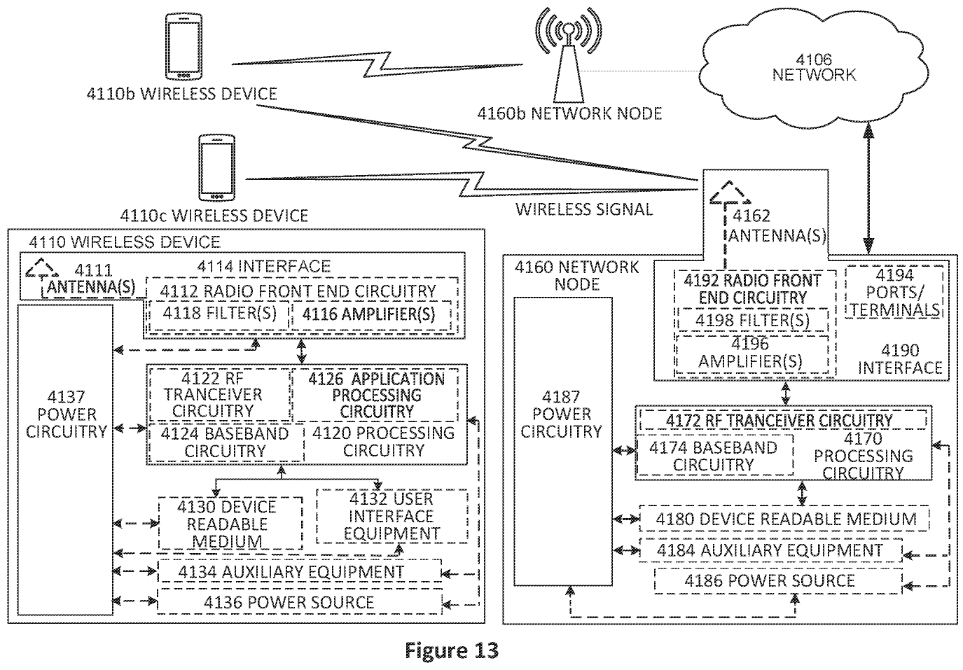

Operations of a core network node 104 (implemented using the structure of FIG. 7) will now be discussed with reference to the flow charts of FIGS. 11-12 according to some embodiments of the present disclosure. For example, modules may be stored in memory 505 of FIG. 7, and these modules may provide instructions so that when the instructions of a module are executed by respective core network node processing circuitry 503, processing circuitry 503 performs respective operations of the flow charts.

Referring initially to FIG. 11, at block 901, processing circuitry 503 signals to a first network node a plurality of alternative quality of service (QoS) profiles. The plurality of alternative QoS profiles includes an indication that a currently supported QoS of the network node cannot fulfil a match to a least preferred alternative QoS profile.

At block 903, processing circuitry 503, receives a message from the first network node when notification control is enabled. The message includes an indication that the first network node cannot fulfil a match to the least preferred alternative QoS profile.

In some embodiments, the receiving a message includes receiving a packet date unit, PDU, session resource notify message.

In some embodiments, the indication includes a defined value indicating that the currently supported QoS of the first network node cannot fulfil a match to a least preferred alternative QoS profile.

In some embodiments, the indication includes an indication in an alternative QoS parameters set index corresponding to the plurality of alternative QoS profiles.

In some embodiments, the alternative QoS parameters set index includes a plurality of parameters having values 1 through N, wherein N is an integer having a value greater than 1, and a parameter having a value of 0 indicating that none of the parameters having values 1 through N can be supported.

Referring now to FIG. 12, in some embodiments, at block 1001, processing circuitry 503 signals a handover request message to the first network node.

Responsive to the request, at block 1003, processing circuitry 503 receives from the network node a handover request acknowledgement message including an index from the alternative QoS parameters set index. The index indicates that none of the alternate QoS parameters can be supported by the first network node.

At block 1005, based on the received index, processing circuitry 503 decides that no handover to the first network node is possible.

Various operations from the flow chart of FIG. 12 may be optional with respect to some embodiments of core network nodes and related methods. Regarding methods of example embodiment 16 (set forth below), for example, the operations of blocks 1001-1005 of FIG. 12 may be optional.

Further discussion of inventive concepts is provided in the document attached at the end of this disclosure at Appendix 1, entitled “3GPP TSG-SA2 Meeting #139E, S2-2004228, Electronic Meeting, 1-12 Jun., 2020, Change Request 23.501 CR 2379, current version 16.4.0, Capability for HPLMN to understand whether or not the NG-RAN node supports Alternative QoS Profiles” (Appendix 1).

Example embodiments are discussed below. Reference numbers/letters are provided in parenthesis by way of example/illustration without limiting example embodiments to particular elements indicated by reference numbers/letters.

Embodiment 1. A method performed by a first network node (102, 400) of a telecommunications network (100), the method comprising:
checking (601) whether a value of a guaranteed flow bit rate, GFBR, parameter fulfils a match to one of a plurality of alternative quality of service (QoS) profiles, wherein the plurality of alternative QoS profiles comprises an indication that a currently supported QoS of the first network node cannot fulfil a match to a least preferred alternative QoS profile; and
responsive to the checking, signalling (603) a message to a core network node when notification control is enabled, the message including an indication that the first network node cannot fulfil the match to the least preferred alternative QoS profile.

Embodiment 2. The method of Embodiment 1, wherein the signalling a message comprises signalling a packet date unit, PDU, session resource notify message.

Embodiment 3. The method of Embodiment 1, further comprising:
receiving (701) from a second network node a request for a handover;
responsive to receiving the request, signalling (703) a message to the second network node, the message including the indication that the first network node cannot fulfil the match to the least preferred alternative QoS profile.

Embodiment 4. The method of any of Embodiments 1 to 3, wherein the indication comprises a defined value indicating that the currently supported QoS of the first network node cannot fulfil a match to a least preferred alternative QoS profile.

Embodiment 5. The method of Embodiment 4, wherein the indication comprises an indication in an alternative QoS parameters set index corresponding to the plurality of alternative QoS profiles

Embodiment 6. The method of Embodiment 5, wherein the alternative QoS parameters set index is received as a portion of at least one of:
a supported alternative QoS parameters received during a path switch request from the core network node;
an F1 notify message received from the core network node; and
a signalling of QoS flow information over E1 to a central unit of the first network node, wherein the first network node comprises a gNodeB having a split architecture.

Embodiment 7. The method of Embodiment 5, further comprising:
receiving (801) a handover request message from the core network node; and
responsive to the handover request message, signalling (803) to the core network node an index from the alternative QoS parameters set index, wherein the index indicates that none of the alternate QoS parameters can be supported by the first network node.

Embodiment 8. The method of Embodiment 7, wherein the index indicates to the core network node that no handover to the first network node is possible.

Embodiment 9. The method of any of Embodiments 1 to 8, wherein the alternative QoS parameters set index comprises a plurality of parameters having values 1 through N, wherein N is an integer having a value greater than 1, and a parameter having a value of 0 indicating that none of the parameters having values 1 through N can be supported.

Embodiment 10. A first network node (102, 400) of a telecommunications network (100), the first network node comprising:
a processor (403); and
memory (405) coupled with the processor, wherein the memory comprises instructions that when executed by the processor cause the processor to perform operations comprising:
checking whether a value of a guaranteed flow bit rate, GFBR, parameter fulfils a match to one of a plurality of alternative quality of service (QoS) profiles, wherein the plurality of alternative QoS profiles comprises an indication that a currently supported QoS of the first network node cannot fulfil a match to a least preferred alternative QoS profile; and
responsive to the checking, signalling a message to a core network node when notification control is enabled, the message including an indication that the first network node cannot fulfil the match to the least preferred alternative QoS profile.

Embodiment 11. The first network node of Embodiment 10, wherein the memory (405) comprises further instructions that when executed by the processor (403) cause the processor (403) to perform operations according to any of Embodiments 2-10.

Embodiment 12. A computer program product comprising computer-executable instructions configured to, when the computer-executable instructions are executed on a processor 403) comprised in the first network node (102, 400), cause the first network node (102, 400) to perform operations comprising:
checking whether a value of a guaranteed flow bit rate, GFBR, parameter fulfils a match to one of a plurality of alternative quality of service (QoS) profiles, wherein the plurality of alternative QoS profiles comprises an indication that a currently supported QoS of the first network node cannot fulfil a match to a least preferred alternative QoS profile; and
responsive to the checking, signalling a message to a core network node when notification control is enabled, the message including an indication that the first network node cannot fulfil the match to the least preferred alternative QoS profile.

Embodiment 13. The computer program product of Embodiment 12 comprising further computer-executable instructions configured to, when the computer-executable instructions are executed on a processor comprised in the first network node (102, 400), cause the first network node (102, 400) to perform the method according to any one of Embodiments 2-10.

Embodiment 14. A computer program product comprising a computer-readable storage medium, the computer-readable storage medium having computer-executable instructions configured to, when the computer-executable instructions are executed on a processor comprised in the first network node (102, 400), cause the first network node (102, 400) to perform operations comprising:
checking whether a value of a guaranteed flow bit rate, GFBR, parameter fulfils a match to one of a plurality of alternative quality of service (QoS) profiles, wherein the plurality of alternative QoS profiles comprises an indication that a currently supported QoS of the first network node cannot fulfil a match to a least preferred alternative QoS profile; and
responsive to the checking, signalling a message to a core network node when notification control is enabled, the message including an indication that the first network node cannot fulfil the match to the least preferred alternative QoS profile.

Embodiment 15. The computer program product of Embodiment 14 having further computer-executable instructions configured to, when the further computer-executable instructions are executed on a processor comprised in the first network node, cause the first network node to perform the method according to any one of Embodiments 2-10.

Embodiment 16. A method performed by a core network node (104, 500) in a telecommunications network (100), the method comprising:
signalling (901) to a first network node a plurality of alternative quality of service (QoS) profiles, wherein the plurality of alternative QoS profiles comprises an indication that a currently supported QoS of the network node cannot fulfil a match to a least preferred alternative QoS profile; and
receiving (903) a message from the first network node when notification control is enabled, the message including an indication that the first network node cannot fulfil a match to the least preferred alternative QoS profile.

Embodiment 17. The method of Embodiment 16, wherein the receiving a message comprises receiving a packet date unit, PDU, session resource notify message.

Embodiment 18. The method of any of Embodiments 16 to 17, wherein the indication comprises a defined value indicating that the currently supported QoS of the first network node cannot fulfil a match to a least preferred alternative QoS profile.

Embodiment 19. The method of Embodiment 18, wherein the indication comprises an indication in an alternative QoS parameters set index corresponding to the plurality of alternative QoS profiles.

Embodiment 20. The method of Embodiment 19, wherein the alternative QoS parameters set index comprises a plurality of parameters having values 1 through N, wherein N is an integer having a value greater than 1, and a parameter having a value of 0 indicating that none of the parameters having values 1 through N can be supported.

Embodiment 21. The method of any of Embodiments 19 to 20, wherein the alternative QoS parameters set index is signalled as a portion of at least one of:
a supported alternative QoS parameters signalled to the network node during a path switch request;
an F1 notify message from the core network node; and
a signalling of QoS flow information over E1 to a central unit of the first network node, wherein the first network node comprises a gNodeB having a split architecture.

Embodiment 22. The method of Embodiment 20, further comprising:
signalling (1001) a handover request message to the first network node; and
responsive to the request, receiving (1003) from the network node a handover request acknowledgement message including an index from the alternative QoS parameters set index, wherein the index indicates that none of the alternate QoS parameters can be supported by the first network node.

Embodiment 23. The method of Embodiment 22, further comprising:
based on the received index, deciding (1005) that no handover to the first network node is possible.

Embodiment 24. A core network node (104, 500) of a telecommunications network (100), the core network node comprising:
a processor (503); and
memory (505) coupled with the processor, wherein the memory comprises instructions that when executed by the processor cause the processor to perform operations comprising:
signalling to a first network node a plurality of alternative quality of service (QoS) profiles, wherein the plurality of alternative QoS profiles comprises an indication that a currently supported QoS of the network node cannot fulfil a match to a least preferred alternative QoS profile; and
receiving a message from the first network node when notification control is enabled, the message including an indication that the first network node cannot fulfil a match to the least preferred alternative QoS profile.

Embodiment 25. The core network node of Embodiment 24, wherein the memory (505) comprises further instructions that when executed by the processor (503) cause the processor (503) to perform operations according to any of Embodiments 17-23.

Embodiment 26. A computer program product comprising computer-executable instructions configured to, when the computer-executable instructions are executed on a processor (503) comprised in the core network node (104, 500), cause the core network node (104, 500) to perform operations comprising:
signalling to a first network node a plurality of alternative quality of service (QoS) profiles, wherein the plurality of alternative QoS profiles comprises an indication that a currently supported QoS of the network node cannot fulfil a match to a least preferred alternative QoS profile; and
receiving a message from the first network node when notification control is enabled, the message including an indication that the first network node cannot fulfil a match to the least preferred alternative QoS profile.

Embodiment 27. The computer program product of Embodiment 25 comprising further computer-executable instructions configured to, when the computer-executable instructions are executed on a processor comprised in the core network node (104, 500), cause the core network node (104, 500) to perform the method according to any one of Embodiments 17-23.

Embodiment 28. A computer program product comprising a computer-readable storage medium, the computer-readable storage medium having computer-executable instructions configured to, when the computer-executable instructions are executed on a processor comprised in the core network node (104, 500), cause the core network node (104, 500) to perform operations comprising:
signalling to a first network node a plurality of alternative quality of service (QoS) profiles, wherein the plurality of alternative QoS profiles comprises an indication that a currently supported QoS of the network node cannot fulfil a match to a least preferred alternative QoS profile; and
receiving a message from the first network node when notification control is enabled, the message including an indication that the first network node cannot fulfil a match to the least preferred alternative QoS profile.

Embodiment 29. The computer program product of Embodiment 28 having further computer-executable instructions configured to, when the further computer-executable instructions are executed on a processor comprised in the core network node, cause the core network node to perform the method according to any one of Embodiments 17-23.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

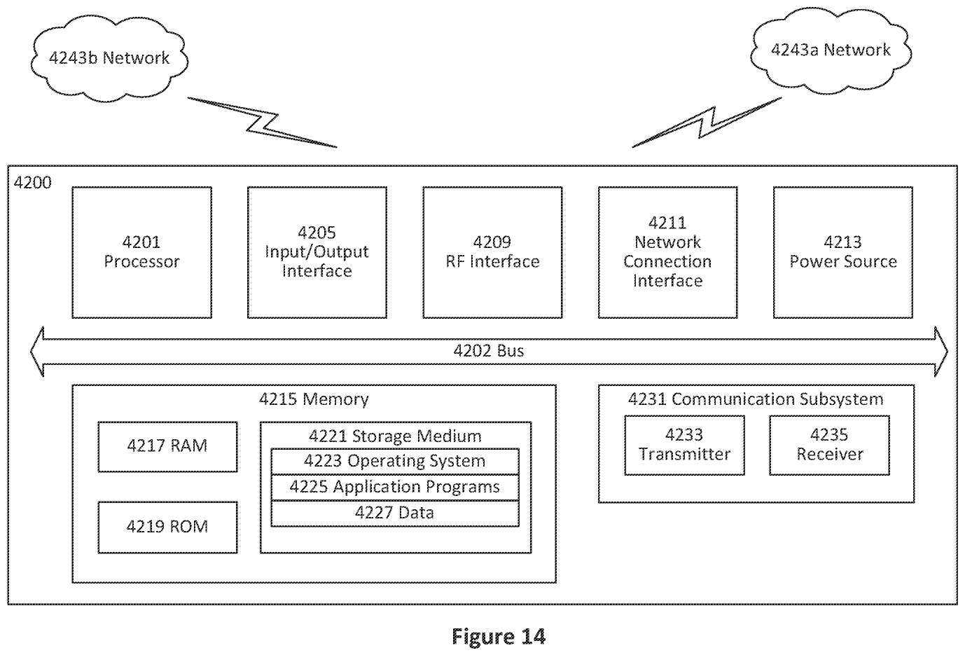

FIG. 13 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 4106, network nodes 4160 and 4160b, and wireless devices (WDs) 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the Institute Electrical and Electronics Engineers (IEEE) 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices. Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MM Es), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as multi-input and multi-output (MIMO). In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 13 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a Universal Serial Bus (USB) port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

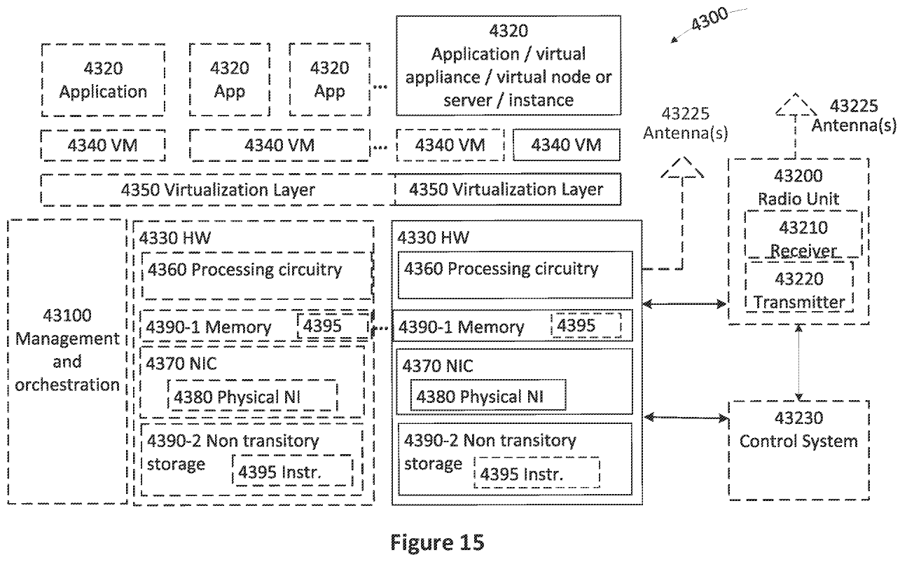

FIG. 14 illustrates a user equipment (UE) in accordance with some embodiments.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 14, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

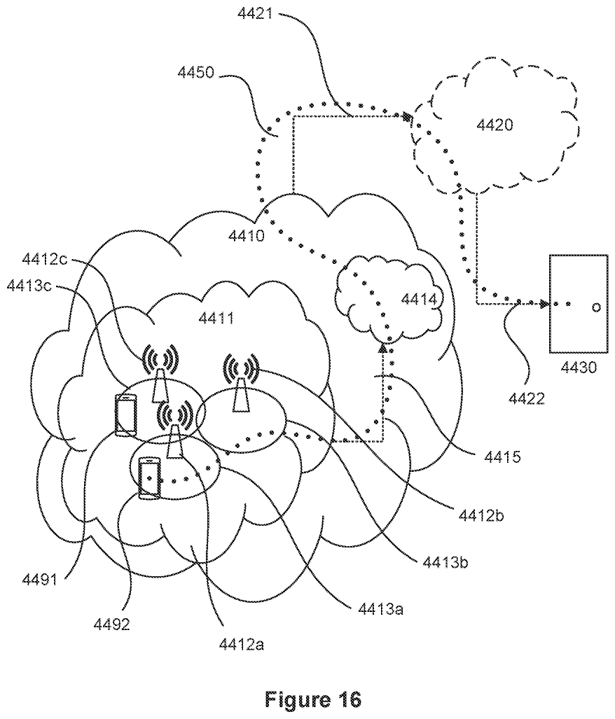

FIG. 15 illustrates a virtualization environment in accordance with some embodiments.

FIG. 15 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 15, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 15.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

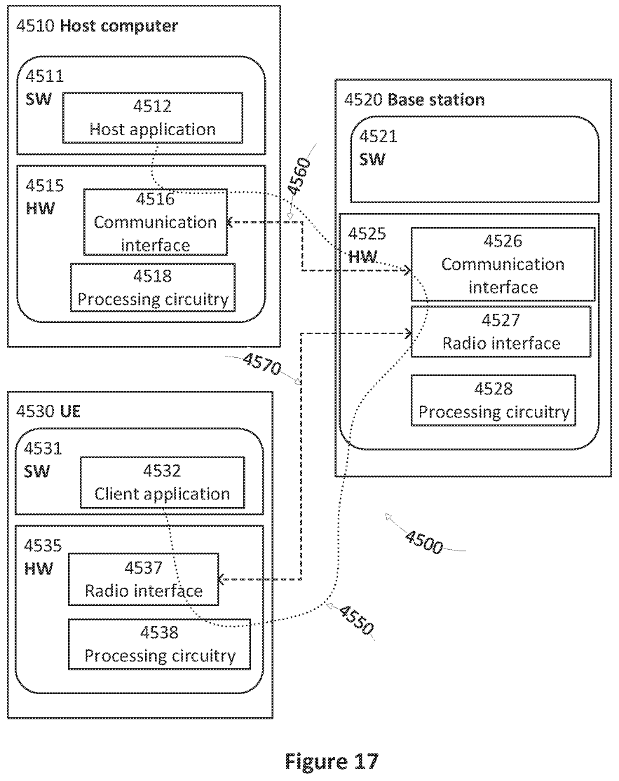

FIG. 16 illustrates a telecommunication network connected via an intermediate network to a host computer in accordance with some embodiments.

With reference to FIG. 16, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 16 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signalling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

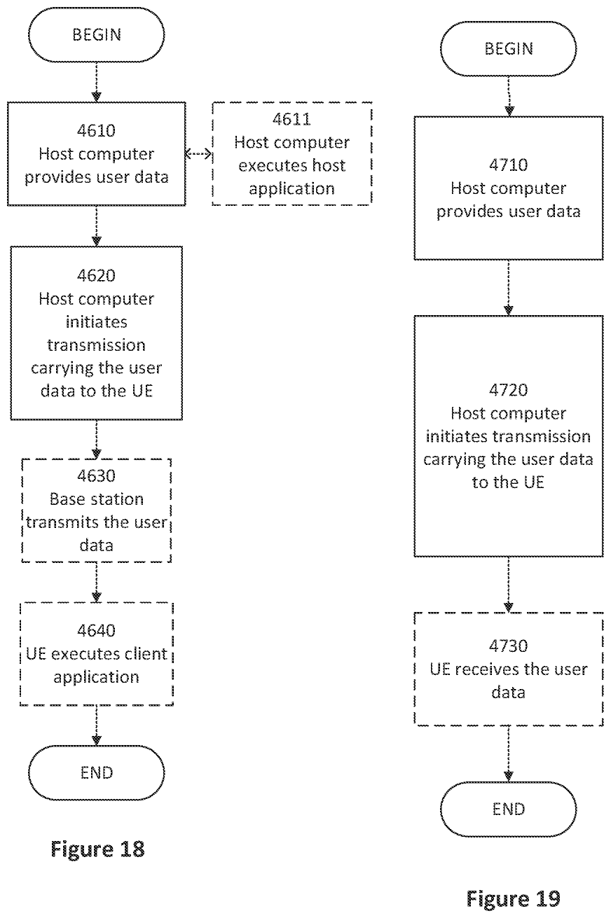

FIG. 17 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 17. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 17) served by base station 4520. Communication interface 4526 may be configured to facilitate connection 4560 to host computer 4510. Connection 4560 may be direct or it may pass through a core network (not shown in FIG. 16) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 17 may be similar or identical to host computer 4430, one of base stations 4412a, 4412b, 4412c and one of UEs 4491, 4492 of FIG. 16, respectively. This is to say, the inner workings of these entities may be as shown in FIG. 17 and independently, the surrounding network topology may be that of FIG. 17.

In FIG. 17, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signalling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

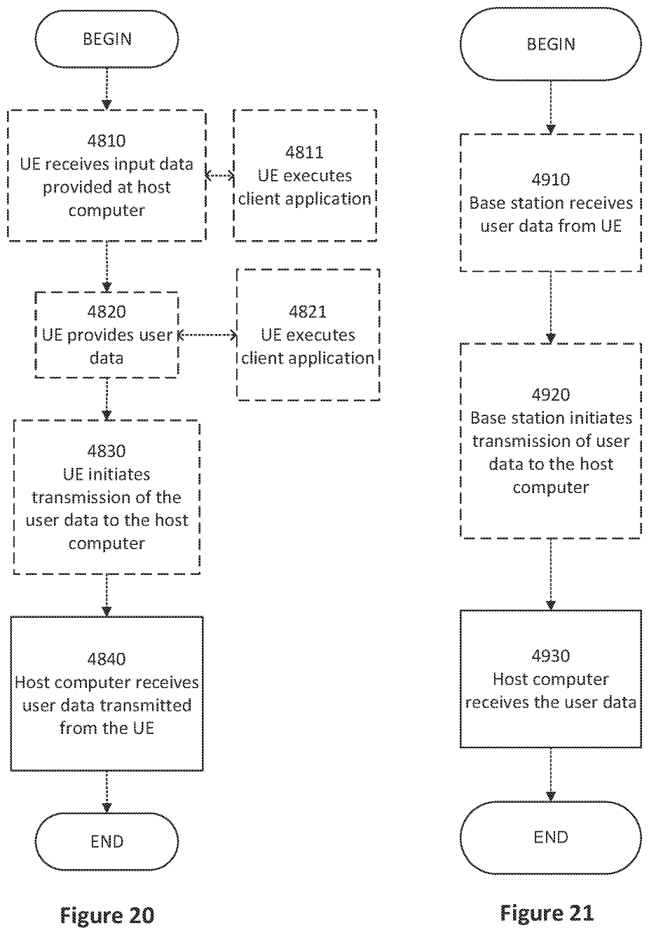

FIG. 18 illustrates methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 19 illustrates methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

FIG. 20 illustrates methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 21 illustrates methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Abbreviations

At least some of the following abbreviations may be used in this disclosure. If there is an inconsistency between abbreviations, preference should be given to how it is used above. If listed multiple times below, the first listing should be preferred over any subsequent listing(s).
1× RTT CDMA2000 1× Radio Transmission Technology
3GPP 3rd Generation Partnership Project
5G 5th Generation
ABS Almost Blank Subframe
ACK Acknowledgement
AP Application Protocol
ARQ Automatic Repeat Request
AWGN Additive White Gaussian Noise
BCCH Broadcast Control Channel
BCH Broadcast Channel
BSR Buffer Status Report
BWP Bandwidth Part
CA Carrier Aggregation
CC Carrier Component
CCCH SDU Common Control Channel SDU
CDMA Code Division Multiplexing Access
CE Control Element
CGI Cell Global Identifier
CIR Channel Impulse Response
CP Control Plane
CPICH Common Pilot Channel
CPICH Ec/No CPICH Received energy per chip divided by the power density in the band
CQI Channel Quality Indicator
C-RNTI Cell Radio Network Temporary Identifier
CSI Channel State Information
DC Dual Connectivity
DCCH Dedicated Control Channel
DCI Downlink Control Information
DL Downlink
DM Demodulation
DMRS Demodulation Reference Signal
DRB Data Radio Bearer
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB or (EUTRAN) base station
ePDCCH enhanced Physical Downlink Control Channel
E-RAB EUTRAN Radio Access Bearer
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR or NR base station
GNSS Global Navigation Satellite System
GSM Global System for Mobile communication
GTP-U GPRS Tunneling Protocol-User Plane
HARQ Hybrid Automatic Repeat Request
HO Handover
HSPA High Speed Packet Access
HRPD High Rate Packet Data
IP Internet Protocol
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MCG Master Cell Group
MDT Minimization of Drive Tests
MeNB Master eNB
MgNB Master gNB
MIB Master Information Block
MME Mobility Management Entity
MN Master Node
MSC Mobile Switching Center
NACK Negative Acknowledgement
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PCI Physical Cell Identity
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSCell Primary SCell
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLF Radio Link Failure
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SCG Secondary Cell Group
SCTP Stream Control Transmission Protocol
SDU Service Data Unit
SeNB Secondary eNB
SFN System Frame Number
SGW Serving Gateway
SI System Information
SIB System Information Block
SINR Signal to Interference plus Noise Radio
SN Secondary Node
SNR Signal to Noise Ratio
SON Self Optimized Network
SR Scheduling Request
SRB Signalling Radio Bearer
SS Synchronization Signal
SSS Secondary Synchronization Signal
SUL Supplementary uplink
TDD Time Division Duplex
TDOA Time Difference of Arrival
TEID Tunnel Endpoint Identifier
TNL Transport Network Layer
TOA Time of Arrival
TSS Tertiary Synchronization Signal
TTI Transmission Time Interval
UCI Uplink Control Information
UDP User Datagram Protocol
UE User Equipment
UL Uplink
UMTS Universal Mobile Telecommunication System
UP User Plane
USIM Universal Subscriber Identity Module
UTDOA Uplink Time Difference of Arrival
UTRA Universal Terrestrial Radio Access
UTRAN Universal Terrestrial Radio Access Network
URLLC Ultra Reliable Low Latency Communication
WCDMA Wide CDMA
WLAN Wide Local Area Network
X2 Interface between base stations

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method for managing a quality of service, QoS, in a telecommunications network, wherein the method is performed by a first network node of the telecommunications network, the method comprising:
if the first network node is unable to fulfil a first quality of service, QoS, indicated in a least preferred alternative QoS profile of one or more alternative QoS profiles:
signalling, to a core network node, a first message comprising a first predefined index that indicates that the first network node is unable to fulfil the first QoS indicated in the least preferred alternative QoS profile, wherein the first predefined index is an integer value of zero.

2. A method as claimed in claim 1, wherein:
the first predefined index signals to the core network node that:
the first network node supports attempting to fulfil the least preferred alternative QoS profile and/or any other alternative QoS profile of the one or more alternative QoS profiles; and/or
the first network node is unable to fulfil any of the one or more alternative QoS profiles.

3. The method as claimed in claim 1, wherein:
the first network node is unable to fulfil the first QoS if a second QoS that the first network node is able to fulfil does not match the first QoS.

4. The method as claimed in claim 1, wherein:
the first QoS is indicated in the least preferred alternative QoS profile by one or more first QoS parameters.

5. The method as claimed in claim 4, wherein:
the one or more first QoS parameters comprise any one or more of:
a guaranteed flow bit rate, GFBR;
a packet delay budget, PDB;
a packet error rate, PER;
a QoS Identifier, QI; and
a Maximum Flow Bit Rate, MFBR.

6. The method as claimed in claim 4, wherein:
the second QoS is indicated by one or more second QoS parameters; and
the second QoS does not match the first QoS if any one of the one or more second QoS parameters do not match a respective one of the one or more first QoS parameters.

7. (canceled)

8. (canceled)

9. (canceled)

10. The method as claimed in claim 1, wherein:
the first predefined index is one of a set of predefined indices comprising at least one second predefined index,
wherein each second predefined index corresponds to one of the one or more alternative QoS profiles.

11. The method as claimed in claim 10, the method comprising:
receiving the set of predefined indices from the core network node.

12. The method as claimed in claim 10, wherein:
each second predefined index is a different integer value.

13. The method as claimed in claim 12, wherein:
each second predefined index is a different integer value from one to N, wherein N corresponds to the number of alternative QoS profiles.

14. The method as claimed in claim 1, wherein:
the least preferred alternative QoS profile is an alternative QoS profile with a lowest priority out of the one or more alternative QoS profiles.

15. The method as claimed in claim 1, wherein:
if the first network node is able to fulfil a third QoS indicated in an alternative QoS profile of the one or more alternative QoS profiles:
signalling, to the core network node, a second message comprising an indication that indicates the alternative QoS profile that the first network node is able to fulfil.

16. The method as claimed in claim 15, wherein:
the first network node is able to fulfil the third QoS subsequent and/or prior to the first network node being unable to fulfil the first QoS.

17. The method as claimed in claim 15, wherein:
the alternative QoS profile that the first network node is able to fulfil is the alternative QoS profile with a highest priority out of the one or more alternative QoS profiles that the first network node is able to fulfil.

18. The method as claimed in claim 15, wherein:
the third QoS is the first QoS and the alternative QoS profile that the first network node is able to fulfil is the least preferred alternative QoS profile.

19. The method as claimed in claim 15, wherein:
the indication is a second predefined index corresponding to the alternative QoS profile that the first network node is able to fulfil.

20. The method as claimed in claim 1, wherein:
the one or more alternative QoS profiles are alternatives to a requested QoS profile.

21. The method as claimed in claim 20, wherein:
the method is performed in response to the first network node being unable to fulfil the requested QoS profile.

22. The method as claimed in claim 1, the method comprising:
receiving the one or more alternative QoS profiles from the core network node.

23. The method as claimed in claim 1, the method comprising:
checking if the first network node fulfils at least one QoS profile of the one or more alternative QoS profiles.

24. The method as claimed in claim 23, wherein:
checking if the first network node fulfils at least one QoS profile of the one or more alternative QoS profiles comprises:
checking if the first network node fulfils at least the least preferred QoS profile.

25. The method as claimed in claim 23, wherein:
checking if the first network node fulfils at least one QoS profile of the one or more alternative QoS profiles comprises:
checking the one or more alternative QoS profiles in an order according to a priority corresponding to each of the one or more alternative QoS profiles, wherein the least preferred alternative QoS profile is the alternative QoS profile with the lowest priority.

26. The method as claimed in claim 1, wherein:
the method is performed in response to a request and/or the first message is a response to the request, wherein the request is:
a request for a protocol data unit, PDU, session resource;
a request for a handover of a user equipment from the first network node to a second network node; or
a request to switch a path for signalling from a user equipment to the core network node.

27. The method as claimed in claim 26, wherein:
the first message is the response to the request for the handover and the first predefined index signals to the core network node that the handover is not possible.

28. The method as claimed in claim 1, wherein:
the first message is signalled to the core network node in response to:
a control plane of a centralised unit of the first network node receiving a third message from a distributed unit of the first network node, wherein the third message comprises the first predefined index; and/or
a user plane of the centralised unit of the first network node receiving a fourth message from the control plane of the centralised unit of the first network node, wherein the fourth message comprises the first predefined index.

29. The method as claimed in claim 28, the method comprising:
if the first network node is unable to fulfil the first QoS indicated in the least preferred alternative QoS profile:
signalling the third message from the distributed unit of the first network node to the control plane of the centralised unit of the first network node; and/or
signalling the fourth message from the control plane of the centralised unit of the first network node to the user plane of the centralised unit of the first network node.

30. The method as claimed in claim 1, wherein:
the first predefined index is an Information Element, IE, of the first message.

31. The method as claimed in claim 1, wherein:
the method is performed when notification control has been enabled.

32. The method as claimed in claim 1, wherein:
the method is performed in response to a QoS flow establishment and/or modification.

33. The method as claimed in claim 32, wherein:
the QoS flow establishment and/or modification is rejected if the first network node is unable to fulfil the first QoS.

34. The method as claimed in claim 1, wherein:
the first network node is a radio access network, RAN, node; and/or
the core network node is a session management function, SMF, node.

35. (canceled)

36. (canceled)

37. A method for managing a quality of service, QoS, in a telecommunications network, wherein the method is performed by a core network node in the telecommunications network, the method comprising:
if a first network node is unable to fulfil a first quality of service, QoS, indicated in a least preferred alternative QoS profile of one or more alternative QoS profiles:
receiving, from the first network node, a first message comprising a first predefined index that indicates that the first network node is unable to fulfil the first QoS indicated in the least preferred alternative QoS profile, wherein the first predefined index is an integer value of zero.

38. A method as claimed in claim 37, wherein:
the first predefined index signals to the core network node that:
the first network node supports attempting to fulfil the least preferred alternative QoS profile and/or any other alternative QoS profile of the one or more alternative QoS profiles; and/or
the first network node is unable to fulfil any of the one or more alternative QoS profiles.

39. The method as claimed in claim 37, wherein:
the first network node is unable to fulfil the first QoS if a second QoS that the first network node is able to fulfil does not match the first QoS.

40. The method as claimed in claim 37, wherein:
the first QoS is indicated in the least preferred alternative QoS profile by one or more first QoS parameters.

41. The method as claimed in claim 40, wherein:
the one or more first QoS parameters comprise any one or more of:
a guaranteed flow bit rate, GFBR;
a packet delay budget, PDB;
a packet error rate, PER;
a QoS Identifier, QI; and
a Maximum Flow Bit Rate, MFBR.

42. The method as claimed in claim 40, wherein:
the second QoS is indicated by one or more second QoS parameters; and
the second QoS does not match the first QoS if any one of the one or more second QoS parameters do not match a respective one of the one or more first QoS parameters.

43. (canceled)

44. (canceled)

45. (canceled)

46. The method as claimed in claim 37, wherein:
the first predefined index is one of a set of predefined indices comprising at least one second predefined index,
wherein each second predefined index corresponds to one of the one or more alternative QoS profiles.

47. The method as claimed in claim 46, the method comprising:
signalling the set of predefined indices to the first network node.

48. The method as claimed in claim 46, wherein:
each second predefined index is a different integer value.

49.-71. (canceled)
